(19) United States
(12) Patent Application Publication
(10) Pub. No.: US 2024/0301151 A1
(43) Pub. Date: Sep. 12, 2024

(54) A FILM MATERIAL

(71) Applicant: VARDEN PROCESS PTY LTD, Braeside, Victoria (AU)

(72) Inventors: Boon Mian TEO, Braeside, Victoria (AU); Matthew POTTAGE, Braeside, Victoria (AU); Jenicka LY, Braeside, Victoria (AU)

(21) Appl. No.: 18/562,658

(22) PCT Filed: May 20, 2022
(86) PCT No.: PCT/AU2022/050489

§ 371 Date: Nov. 20, 2023

(30) Foreign Application Priority Data
May 21, 2021 (AU) 2021901524

(51) Int. Cl. C08J 5/18; B65D 65/42; B65D 65/46

(52) U.S. Cl. CPC C08J 5/18; B65D 65/42; B65D 65/466; C08J 2301/12; C08J 2467/02

(57) ABSTRACT

A film material that is a blend of a first polymer, and a second polymer. The first polymer is synthesized from one or more bio-based monomers, and has a molecular weight that is less than or equal to 60 kilodaltons. The second polymer is one of: a carbohydrate, and a functionalised carbohydrate derived from one or more bio-based materials. The ratio of first polymer to second polymer within the film material is at least 25:75 by weight.

A packaging material has a substrate, and a layer that is formed of the film material, which is assembled into a substantially continuous film on a carrying surface of the substrate. The layer is formed to a thickness that is efficacious in providing a barrier to transmission of oxygen and/or water vapour to the carrying surface of the substrate.

### FIELD OF THE INVENTION

The present invention relates to a film material for use in packaging, to packaging material that incorporates a film material, and to a process for forming a film material.

### BACKGROUND

There is increasing demand for bio-sourced materials and biodegradable materials that are suitable for use in commodity packaging. This demand is at least in part due to increasing awareness of sustainability problems of synthetic polymers, that are linked to sourcing of raw materials (including crude oil, natural gas, and coal) for synthesis, and end-of-life issues of these synthetic polymers.

Some synthetic polymers, such as polyethylene (PE), polyethylene terephthalate (PET), and polypropylene (PP), have characteristics that are desirable for commodity packaging. These characteristics include low permeability to oxygen gas and/or water vapour, high strength, and durability. These characteristics provide benefits to producers and supply chains of consumable goods, and to the ultimate consumers of consumable goods that are packaged in packaging that is formed of, or with synthetic polymers, and many of these benefits relate to the shelf-life of the packaged consumable goods.

Known bio-sourced polymers have limited suitability for use in commodity packaging, particularly where low Oxygen Transmission Rate (“OTR”), and/or low Water Vapour Transmission Rate (“WVTR”, and which is also known as Moisture Vapour Transmission Rate) is required. By way of example, polylactic acid (PLA) is brittle, susceptible to water uptake, and is a poor barrier to oxygen and water vapour transmission. Polyglycolic acid (PGA) has better barrier properties and is stronger than PLA, but degrades faster.

There is a need for a bio-sourced polymer that is able to form a film material to thereby be appropriate for use in packaging of consumer goods, and/or at least provides a useful alternative.

### SUMMARY

There is provided a film material comprising a blend of:
a first polymer that is synthesized from one or more bio-based monomers, the first polymer having a molecular weight that is less than or equal to 60 kilodaltons; and
a second polymer that is one of: a carbohydrate, and a functionalised carbohydrate derived from one or more bio-based materials,
wherein the ratio of first polymer to second polymer within the film material is at least 25:75 by weight.

Preferably, the first polymer has a molecular weight that is less than or equal to 30 kilodaltons. More preferably, the first polymer has a molecular weight that is less than or equal to 15 kilodaltons. More preferably still, the first polymer has a molecular weight that is in the range of 4 kilodaltons to 8 kilodaltons. Even more preferably, the first polymer has a molecular weight that is in the range of 4.5 kilodaltons to 7.5 kilodaltons. In certain particular embodiments, the first polymer has a molecular weight that is approximately 5.6 kilodaltons.

In some instances, the first polymer has a polydispersity index that is less than or equal to 3. In more particular instances, the first polymer has a polydispersity index that is less than or equal to 2. In even more particular instances, the first polymer has a polydispersity index that is in the range of 1.35 to 1.75. In certain examples, the first polymer has a polydispersity index that is in the range of 1.5 to 1.6.

Preferably, the ratio of first polymer to second polymer within the film material is in the range of 80:20 to 10:90 by weight. More preferably, the ratio of first polymer to second polymer within the film material is in the range of 75:25 to 25:75 by weight. Even more preferably, the ratio of first polymer to second polymer within the film material is approximately 50:50 by weight.

In certain embodiments, the first polymer is a polyester, a polyvinyl ester, a polyvinyl ester derivative, or polyether, or combinations thereof.

In embodiments in which the first polymer includes a polyester, that polyester is synthesized from one or more monomers of: lactic acid, glycolic acid, cyclic esters, butanediol. More preferably, the first polymer includes one or more of: poly(lactic acid) (PLA), poly(lactic-co-glycolic acid) (PLGA), polyglycolic acid (PGA), poly(caprolactone) (PCL), poly(butylene adipate terephthalate) (PBAT), poly(butylene succinate) (PBS), and poly(butylene succinate-co-butylene adipate) (PBSA). In embodiments in which the first polymer includes a copolymer, the copolymer can be in the form of alternating copolymers, or as block copolymer segments.

In embodiments in which the first polymer includes a polyester that is produced by bacterial fermentation, the first polymer includes one or more of: polyhydroxylalkanoate (PHA), and polyhydroxybutyrate (PHB).

In embodiments in which the first polymer includes a polyvinyl ester, or polyvinyl ester derivative, the first polymer includes one or more of poly(vinyl acetate) (PVAc), and poly(vinyl alcohol) (PVOH).

In embodiments in which the first polymer includes a polyether that is produced from glycols, the first polymer includes polyethylene glycol (PEG).

Preferably, the first polymer is an aliphatic polyester. Examples of preferred polyesters include for example, poly(lactic acid), poly(glycolic acid), copolymers of lactic and glycolic acid, copolymers of lactic and glycolic acid with poly(ethylene glycol), poly(e-caprolactone), and poly(3-hydroxybutyrate).

In particularly preferred embodiments, the first polymer is synthesized from monomers of lactic acid and glycolic acid. Preferably, the first polymer is poly(lactic-co-glycolic acid) (PLGA).

The poly(lactic-co-glycolic acid) can be formed from lactic acid and glycolic acid at a monomer ratio in the range of 40:60 to 85:15. More preferably, the poly(lactic-co-glycolic acid) can be formed from lactic acid and glycolic acid at a monomer ratio in the range of 50:50 to 75:25. In at least some embodiments, the poly(lactic-co-glycolic acid) is formed so as to have lactic and glycolic units at a ratio of approximately 60:40. In other words, the poly(lactic-co-glycolic acid) PLGA is made up of 60% lactic units, and 40% glycolic units.

Alternatively or additionally, the poly(lactic-co-glycolic acid) can be formed from lactic acid and glycolic acid, with approximately equals proportion of lactic acid and glycolic acid monomers present at polymerization.

In some examples, the poly(lactic-co-glycolic acid) is predominantly amorphous. In some alternative examples, the poly(lactic-co-glycolic acid) has a crystallinity that is of no more than 90%. The poly(lactic-co-glycolic acid) can have a crystallinity that is between 30% and 45%.

Preferably, the poly(lactic-co-glycolic acid) is formed using lactic acid monomer with both L isomer and D isomer present at polymerization.

In certain embodiments, the second polymer is cellulose, a cellulose derivative, an alpha glucan, an alpha glucan derivative, a natural polysaccharide (including those derived from algae, and those containing amides), or combinations thereof.

In embodiments in which the second polymer includes cellulose, that cellulose can be one or move of: cellulose, acetylated cellulose derivatives, nitrated cellulose derivatives, alkylated cellulose derivatives, and hemicellulose.

Preferably, the second polymer is an acetylated cellulose derivative. The acetylated cellulose derivative is one or more of: cellulose acetate, cellulose acetate butyrate, and cellulose acetate propionate. In certain embodiments, the acetylated cellulose derivative is cellulose acetate.

In some embodiments, the cellulose acetate has a degree of acetylation that is in the range of 1 to 3. In some applications of the film material, the cellulose acetate has a degree of acetylation of at least 2. In some applications, a degree of acetylation of approximately 2.5 may be desirable. In some alternative applications of the film material, the cellulose acetate has a degree of acetylation of less than 2.

The film material can comprise one or more additive materials to modify one or more of: the rate of oxygen transmission through the film material; the rate of water vapour transmission through the film material; to reduce the brittleness of the film material; the glass transition temperature of the film material; the hydrophobicity; the surface energy of the film material; and the plasticity of the film material.

Non-limiting examples of additive materials include mineral and organic particulates (such as talc, mica, clay, silica, alumina, carbon fibre, carbon black, glass fibre, rock fibre), natural and processed cellulosic materials (such as bagasse, wood, flax, hemp, grass, and grain stalk fibres; and fruit, seed and grain hulls; kenaf; jute; sisal; peanut shells; and other cellulose containing material), waxes, natural polysaccharides (including chitin, and chitosan), and alpha glucans (including starches, and pectin). The amount of additive material within the blend may vary depending upon the polymeric matrix and the desired physical properties of the finished composition.

There is also provided a film material comprising a blend of:
a first polymer that is synthesized from one or more bio-based monomers, the first polymer having a molecular weight that is less than or equal to 60 kilodaltons; and
a second polymer that is one of: a carbohydrate, and a functionalised carbohydrate derived from one or more bio-based materials,
wherein the first and second polymers together form a continuous film.

In certain embodiments, at least a surface layer of the continuous film is formed with the second polymer arranged as a substantially continuous matrix surrounding regions of the first polymer. Within the surface layer, the regions of the first polymer can be of varied size and/or separation.

In some alternative embodiments, at least a surface layer of the continuous film is formed with the first polymer being at least partially dispersed through a matrix of the second polymer.

Preferably, the first polymer has a molecular weight that is less than or equal to 30 kilodaltons. More preferably, the first polymer has a molecular weight that is less than or equal to 15 kilodaltons. More preferably still, the first polymer has a molecular weight that is in the range of 4 kilodaltons to 8 kilodaltons. Even more preferably, the first polymer has a molecular weight that is in the range of 4.5 kilodaltons to 7.5 kilodaltons. In certain particular embodiments, the first polymer has a molecular weight that is approximately 5.6 kilodaltons.

In some instances, the first polymer has a polydispersity index that is less than or equal to 3. In more particular instances, the first polymer has a polydispersity index that is less than or equal to 2. In even more particular instances, the first polymer has a polydispersity index that is in the range of 1.35 to 1.75. In certain examples, the first polymer has a polydispersity index that is in the range of 1.5 to 1.6.

Preferably, the ratio of first polymer to second polymer within the film material is in the range of 80:20 to 10:90 by weight. More preferably, the ratio of first polymer to second polymer within the film material is in the range of 75:25 to 25:75 by weight. Even more preferably, the ratio of first polymer to second polymer within the film material is approximately 50:50 by weight.

In certain embodiments, the first polymer is a polyester, a polyvinyl ester, a polyvinyl ester derivative, or polyether, or combinations thereof.

In embodiments in which the first polymer includes a polyester, that polyester is synthesized from one or more monomers of: lactic acid, glycolic acid, cyclic esters, butanediol. More preferably, the first polymer includes one or more of: poly(lactic acid) (PLA), poly(lactic-co-glycolic acid) (PLGA), polyglycolic acid (PGA), poly(caprolactone) (PCL), poly(butylene adipate terephthalate) (PBAT), poly(butylene succinate) (PBS), and poly(butylene succinate-co-butylene adipate) (PBSA). In embodiments in which the first polymer includes a copolymer, the copolymer can be in the form of alternating copolymers, random copolymers, or as block copolymer segments.

In embodiments in which the first polymer includes a polyester that is produced by bacterial fermentation, the first polymer includes one or more of: polyhydroxylalkanoate (PHA), and polyhydroxybutyrate (PHB).

In embodiments in which the first polymer includes a polyvinyl ester, or polyvinyl ester derivative, the first polymer includes one or more of poly(vinyl acetate) (PVAc), and poly(vinyl alcohol) (PVOH).

In embodiments in which the first polymer includes a polyether that is produced from glycols, the first polymer includes polyethylene glycol (PEG).

Preferably, the first polymer is an aliphatic polyester. Examples of preferred polyesters include for example, poly(lactic acid), poly(glycolic acid), copolymers of lactic and glycolic acid, copolymers of lactic and glycolic acid with poly(ethylene glycol), poly(e-caprolactone), and poly(3-hydroxybutyrate).

In particularly preferred embodiments, the first polymer is synthesized from monomers of lactic acid and glycolic acid. Preferably, the first polymer is poly(lactic-co-glycolic acid) (PLGA).

The poly(lactic-co-glycolic acid) can be formed from lactic acid and glycolic acid at a monomer ratio in the range of 40:60 to 85:15. More preferably, the poly(lactic-co-glycolic acid) can be formed from lactic acid and glycolic acid at a monomer ratio in the range of 50:50 to 75:25. In at least some embodiments, the poly(lactic-co-glycolic acid) is formed so as to have lactic and glycolic units at a ratio of approximately 60:40. In other words, the poly(lactic-co-glycolic acid) PLGA is made up of 60% lactic units, and 40% glycolic units.

Alternatively or additionally, the poly(lactic-co-glycolic acid) can be formed from lactic acid and glycolic acid, with approximately equal proportions of lactic acid and glycolic acid monomers present at polymerization.

In some examples, the poly(lactic-co-glycolic acid) is predominantly amorphous. In some alternative examples, the poly(lactic-co-glycolic acid) has a crystallinity that is of no more than 90%. The poly(lactic-co-glycolic acid) can have a crystallinity that is between 30% and 45%.

Preferably, the poly(lactic-co-glycolic acid) is formed using lactic acid monomer with both L isomer and D isomer present at polymerization.

In certain embodiments, the second polymer is cellulose, a cellulose derivative, an alpha glucan, an alpha glucan derivative, a natural polysaccharide (including those derived from algae, and those containing amides), or combinations thereof.

In embodiments in which the second polymer includes cellulose, that cellulose can be one or move of: cellulose, acetylated cellulose derivatives, nitrated cellulose derivatives, alkylated cellulose derivatives, and hemicellulose.

Preferably, the second polymer is an acetylated cellulose derivative. The acetylated cellulose derivative is one or more of: cellulose acetate, cellulose acetate butyrate, and cellulose acetate propionate. In certain embodiments, the acetylated cellulose derivative is cellulose acetate.

In some embodiments, the cellulose acetate has a degree of acetylation that is in the range of 1 to 3. In some applications of the film material, the cellulose acetate has a degree of acetylation of at least 2. In some applications, a degree of acetylation of approximately 2.5 may be desirable. In some alternative applications of the film material, the cellulose acetate has a degree of acetylation of less than 2.

There is also provided a packaging material that comprises:
a substrate; and
at least one layer that is formed of a film material as previously described, and that is assembled into a substantially continuous film on a carrying surface of the substrate,
wherein the layer is formed to a thickness that is efficacious in providing a barrier to transmission of oxygen and/or water vapour to the carrying surface of the substrate.

Preferably, the, or each layer of film material is formed to a thickness of at least 5 grams/metre² (gsm). The, or each layer of film material can be formed to a thickness of 20 grams/metre² (gsm) or more.

Preferably, the layer of film material is formed to an average thickness that is at least 2.5 μm. More preferably, the layer of film material is formed to an average thickness that is at least 5 μm.

In some embodiments, the carrying surface of the substrate is substantially planar. In some alternative embodiments, the carrying surface of the substrate is non-planar.

In some instances, the layer of film material can define an external surface of the packaging material. In some instances the layer of film material can alternatively or additionally define an internal surface of the packaging material.

In some embodiments, the packaging material defines a concave portion within which a consumable good is to be packaged. The packaging material can be arranged with the layer of film material being between the substrate and the concave portion. Alternatively or additionally, the packaging material can be arranged with substrate between the layer of film material and the concave portion.

Alternatively or more particularly, the layer of film material can be formed on the substrate at a thickness such that the oxygen transmission rate of the packaging material is less than or equal to 30 cubic centimetres per metre squared per day (cm³/(m²×day)), at 23° C., 50% relative humidity. In certain embodiments, the layer of film material can be formed on the substrate at a thickness such that the oxygen transmission rate of the packaging material is less than or equal to 15 cubic centimetres per metre squared per day (cm³/(m²×day)), at 23° C., 50% relative humidity. In some particular embodiments, the layer of film material is formed on the substrate at a thickness such that the oxygen transmission rate of the packaging material is less than or equal to approximately 13 cubic centimetres per metre squared per day (cm³/(m²×day)), at 23° C., 50% relative humidity.

Preferably, the substrate is formed of, or includes pulp fibres that have been processed so as to be assembled into a predetermined shape, and treated to form bonds between the pulp fibres within the substrate, whereby the substrate is able to at least partly retain its shape in an unsupported condition.

In some embodiments, the substrate can be a multilayer material having:
a primary layer that is formed of, or includes pulp fibres that have been processed so as to be assembled into a predetermined shape, and treated to form bonds between the pulp fibres, and
one or more secondary layers that are formed separately of the primary layer and the layers that include the film material.

Preferably, the material of at least some of the secondary layers differs functionally from the primary layer, and the secondary layers.

There is also provided a process for forming a film material, the process involving:
forming a mixture of a first polymer dispersed and/or dissolved within a solvent, the first polymer being synthesized from one or more bio-based monomers and having a molecular weight that is less than or equal to 60 kilodaltons;
adding a second polymer into the mixture such that the second polymer is dispersed and/or dissolved, the second polymer being one of: a carbohydrate, and a functionalised carbohydrate derived from one or more bio-based materials, and
evaporating the solvent from the mixture of solvent, and first and second polymers to form the film material,
wherein the second polymer is added to the mixture such that the feed ratio of second polymer to first polymer within the mixture is at least 25:75 by weight.

Preferably, the second polymer is added to the mixture such that the feed ratio of second polymer to first polymer within the mixture is in the range of 80:20 to 10:90 by weight. More preferably, the second polymer is added to the mixture such that the feed ratio of second polymer to first polymer within the mixture is in the range of 75:25 to 25:75 by weight. Even more preferably, the second polymer is added to the mixture such that the feed ratio of second polymer to first polymer within the mixture is approximately 50:50 by weight.

In particularly preferred embodiments of the process, the first polymer is synthesized from monomers of lactic acid and glycolic acid. Preferably, the first polymer is poly(lactic-co-glycolic acid) (PLGA). The poly(lactic-co-glycolic acid) can be formed from lactic acid and glycolic acid at a monomer ratio in the range of 40:60 to 85:15. More preferably, the poly(lactic-co-glycolic acid) can be formed from lactic acid and glycolic acid at a monomer ratio in the range of 50:50 to 75:25. Alternatively or additionally, the poly(lactic-co-glycolic acid) can be formed from lactic acid and glycolic acid, with approximately equals proportion of lactic acid and glycolic acid monomers present at polymerization.

In particularly preferred embodiments of the process, the second polymer is an acetylated cellulose derivative. In certain embodiments, the acetylated cellulose derivative is cellulose acetate.

Preferably, the first polymer has a molecular weight that is less than or equal to 30 kilodaltons. More preferably, the first polymer has a molecular weight that less than or equal to 15 kilodaltons. More preferably still, the first polymer has a molecular weight that is in the range of 4 kilodaltons to 8 kilodaltons. Even more preferably, the first polymer has a molecular weight that is in the range of 5.6 kilodaltons to 7.5 kilodaltons. In certain particular embodiments, the first polymer has a molecular weight that is approximately 5.6 kilodaltons.

In certain examples, the first polymer has a polydispersity index that is less than or equal to 3. Further, the first polymer can have a polydispersity index that is less than or equal to 2. Further still, the first polymer can have a polydispersity index that is in the range of 1.35 to 1.75. In some examples, the first polymer has a polydispersity index that is in the range of 1.5 to 1.6.

The process can involve selecting a solvent within which both the first and second polymers are dissolvable. Alternatively or additionally, the process can involve selecting a solvent within which both the first and second polymers are dispersible. The solvent can be water and/or one or more volatile liquids. Preferably, the solvent is an organic solvent. More preferably, the solvent is a ketone. Even more preferably, the solvent is acetone.

The process can further involve, at least partly prior to evaporating the solvent, transferring the mixture of solvent, and first and second polymers onto a target surface on which the film material is to be formed.

In some embodiments, the process can further involve selecting the initial quantity of solvent that is sufficient to completely dissolve and/or disperse each of the first and second polymers. More particularly, the process can involve selecting the initial quantity of solvent to achieve a predetermined viscosity of the mixture of solvent, and first and second polymers prior to evaporation of the solvent. Further, the predetermined viscosity can be selected to facilitate application of the mixture of solvent, and first and second polymers to the target surface on which the film material is to be formed. Preferably, the initial quantity of solvent is selected to provide a solvent proportion within the mixture of solvent, and first and second polymers that is between 65% and 95%. More preferably, the initial quantity of solvent is selected to provide a solvent proportion within the mixture of solvent, and first and second polymers that is between 80% and 90%. Even more preferably, the initial quantity of solvent is selected to provide a solvent proportion within the mixture of solvent, and first and second polymers that is approximately 85%.

In some embodiments, evaporating the solvent involves heating the mixture to a temperature that exceeds the glass transition temperature of the first polymer. Evaporating the solvent can alternatively or additionally involve directing an air stream towards the surface of the mixture.

The process can further involve tempering the film material after the solvent has evaporated. Preferably, tempering the film materials involves maintaining the process materials at an elevated temperature for a predetermined period. Preferably, the elevated temperature exceeds the glass transition temperature of the first polymer.

Preferably, the process involves forming the film material to an average thickness in the range of 2.5 to 100 μm. More preferably, the process involves forming the film material to an average thickness in the range of 5 to 50 μm.

In some embodiments, the target surface is a moulding surface, and the process involves applying the mixture of solvent, and first and second polymers onto the moulding surface, and removing the formed film material from the moulding surface.

In certain embodiments, the target surface is a surface of a packaging material component that is to carry the film material, whereby the film material is to bond to the surface of the packaging material component.

Alternatively or additionally, the step of transferring the mixture of the first and second polymers onto the target surface involves applying the mixture to the target surface by extrusion coating, tumble coating, granulation, spray coating, casting, and the like. Many suitable coating methods are known in the art and may be practised by those skilled in the art, having regard to the teaching herein without undue experimentation.

The process can further involve synthesizing the first polymer from a first monomer material and a second monomer material, the synthesizing involving:
creating a feed mixture by adding the second monomer material to an aqueous solution within which the first monomer material is dispersed at a pre-determined molar ratio of first monomer material to second monomer material;
dehydrating the feed mixture under predefined dehydration condition;
oligomerizing the dehydrated feed mixture in a polymerization catalyst;
conducting a post-synthesis workup on the oligomerized feed mixture, and then isolating the first polymer.

The polymerization catalyst can be a Brønsted acid catalyst, a Lewis acid catalyst, or an organic catalyst.

Preferably, the polymerization catalyst is a sulfonic acid. In embodiments in which the polymerization catalyst is a Brønsted acid catalyst, the polymerization catalyst can be one of: methanesulfonic acid, p-toluenesulfonic acid, or trifluoromethanesulfonic acid.

In embodiments in which the polymerization catalyst is a Lewis acid catalyst, the polymerization catalyst can be one or more metal alkoxides. Preferably, the polymerization catalyst is one of: aluminium isopropoxide, tin chloride, urea/potassium alkoxide, Stannous octoate, or tin alkoxide.

In embodiments in which the polymerization catalyst is an organic catalyst, the polymerization catalyst is one or more nucleophilic bases. Preferably, the polymerization catalyst is one of: 4-dimethylaminopyridine, hetrocyclic carbenes, thiourea-amine catalyst, or tris[2-(dimethylamino)ethyl]amine (Me6TREN).

In embodiments in which the first monomer material is lactic acid, and the second monomer material is glycolic acid, the polymerization catalyst is a compound of tin (Sn). In a preferred embodiment, the polymerization catalyst is tin(II) 2-ethylhexanoate (Sn(Oct)₂)).

### BRIEF DESCRIPTION OF THE DRAWINGS

In order that the invention may be more easily understood, an embodiment will now be described, by way of example only, with reference to the accompanying drawings, in which:

FIG. 1: is a graph showing WVTR test results of samples of greaseproof sheets coated with 20 gsm of film materials according to embodiments, the tests performed at 23° C., 50% relative humidity (RH);

FIG. 2: is a graph representing Relative OTR test results of samples of thermoformed pulp fibre sheets each with a coating of film material according to embodiments, and at a coating weight of 20 gsm;

FIG. 3: is a column chart showing Cobb test results of samples of thermoformed pulp fibre sheets coated with film materials according to embodiments;

FIG. 4: is a column chart showing migration test results of samples of thermoformed pulp fibre sheets, some of which are coated with film materials according to embodiments;

FIG. 5: is a scanning electron microscope (SEM) image of a surface of a sample of film material according to an embodiment, the generated to micrometre scale resolution in the image plane;

FIG. 6: is an atomic force microscopy (AFM) image of a surface of a sample of film material according to an embodiment, the image generated to micrometre scale resolution in the image plane;

FIG. 7: is an atomic force microscopy (AFM) image of a portion of surface of the film material shown in FIG. 6, the portion being enlarged to nanometre scale resolution in the image plane;

FIG. 8: is a graph showing the spectrum of a sample of synthesized PLGA, the graph obtained by proton nuclear magnetic resonance (NMR) spectroscopy;

FIG. 9: is a graph showing the molecular weight distribution of a sample of synthesized PLGA, the graph obtained by gel permeation chromatography (GPC) analysis;

FIG. 10: is a graph showing the crystallographic structure of a sample of synthesized PLGA, the graph obtained by x-ray diffraction (XRD) analysis;

FIG. 11: is a graph showing the results of differential scanning calorimetry conducted on a sample of synthesized PLGA;

FIG. 12: is a schematic vertical cross section of a test cell of a MOCON OX-TRAN Oxygen Permeation Analyzer Model 2/22 TruSeal test cell used to obtain OTR results such as those shown in FIG. 2;

FIG. 13: is a schematic view of a Cobb testing apparatus used to obtain Cobb results such as those shown in FIG. 3;

FIGS. 14 to 17: are atomic force microscopy (AFM) images of surfaces of samples of film materials according to embodiments, the image generated to micrometre scale resolution in the image plane;

FIG. 18: is an atomic force microscopy (AFM) phase image of a surface of the samples of film material of FIG. 16, the image generated to micrometre scale resolution in the image plane; and

FIG. 19: is a photograph of a sample of film material according to an embodiment.

### DETAILED DESCRIPTION

Embodiments will now be described with reference to the following examples. It is to be understood that these embodiments and examples are provided by way of illustration of the invention, and that they are in no way limiting to the scope of the invention.

### Example 1: Synthesis of Film Material

### Chemicals:

Poly(lactic-co-glycolic acid) (PLGA):
   as synthesized;
Cellulose acetate (CA):
   obtained from Sigma Aldrich (Product No. 180955),
   in powder form,
   average molecular weight (M̅n̅): 30 kilodaltons,
   acetylation: 39.8% (by weight),
   used as received;
Acetone:
   obtained from Merck (Product No. 100014),
   reagent grade,
   used as received.

The cellulose acetate as obtained from Sigma Aldrich is quoted as having an acetylation of 39.8% by weight, which can alternatively be expressed as a degree of acetylation of approximately 2.45 (which may be rounded up to 2.5).

### Substrate Materials:

High density poly(ethylene) (HDPE) sheet:
   obtained from Plastic Center (Melbourne, Australia)
   1.5 mm thickness (nominal),
   used as received.
Greaseproof sheets:
   compostable brown paper (Glad to be Green®),
   40 gsm,
   retail grade,
   used as received.
Thermoformed pulp fibre sheets:
   formed from raw bagasse fibre that was obtained from Sheeon,
   in a substantially flat form having a sheet weight of 400 gsm,
   as thermoformed by Applicant, and involving:
      a. refinement of the raw bagasse fibre in accordance with the Technical Association of the Pulp and Paper Industry (TAPPI) T248 SP-15 Standard, “Laboratory Beating of Pulp (PFI Mill Method)”, April 2015, to a refinement of 3000 revolutions in the mill, and
      b. use of equipment that included a tool substantially as described and illustrated in International Patent Application No. PCT/AU2020/051248, entitled “A Tool for use in a Thermoforming Process”, and filed in the name of Varden Process Pty Ltd.

### Method:

Desired molar fractions of PLGA and CA were dissolved in acetone and then heated to 20° C. to 30° C., and ideally 25° C., and maintained for up to 2 hours with constant stirring until dissolved, to form a PLGA:CA blend in solution. In various experiments, the PLGA and CA were dissolved at concentrations of 5%, 10%, 15%, and 25% by weight in acetone were trialled.

The PLGA:CA blend in solution was delivered to the selected substrate material, at a mass to achieve a desired coat weight. In various experiments, coat weights of 10 g/m² (also known as “grams per square metre” or “gsm”), 20 gsm, and 30 gsm were trialled. The acetone solvent was driven off by placing the coated sheet in an environment at an elevated temperature and with a cross flow air stream for a predetermined period. Specifically, the acetone solvent was driven off in a drying oven:
at a temperature within the range of 20° C. to 56° C., and ideally 50° C.;
with an average air flow in the range of 1.2 m/s to 3 m/s, and ideally 1.5 m/s; and
for a period in the range of 180 seconds to 340 seconds, and ideally 210 second.

### Analysis:

### Barrier to Water Vapour:

As will be appreciated, in the context of packaging materials, the efficacy of the material as a barrier to water vapour can be a significant factor in the performance of the packaging material.

Samples of films of PLGA:CA blends (as per Table 1, below) formed on greaseproof sheets to a coating weight of 20 gsm were prepared by the method described above. These samples were subjected to water vapour transmission rate (WVTR) tests, with air at 23° C. and 50% relative humidity (RH) as the migration test agent. Additionally, a sample of a film of pure PLGA formed on a greaseproof sheet to a coating weight of 20 gsm was also prepared by the method described above.

TABLE 1

| Sample | PLGA | CA | WVTR (g/ |
|---|---|---|---|
| No. | % | % | (m² × day)) |
| 1 | 100 | 0 | 53.99 |
| 2 | 75 | 25 | 65.15 |
| 3 | 50 | 50 | 78.53 |
| 4 | 25 | 75 | 132.35 |

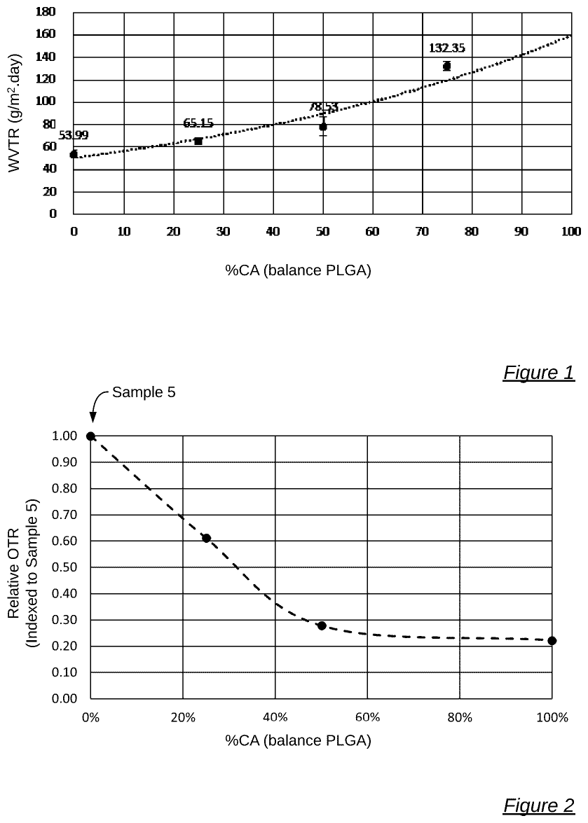

The above results are shown graphically in FIG. 1. These results indicate that the water vapour barrier properties of film material that is a PLGA:CA blend decreases with increasing proportion of cellulose acetate (CA).

### Barrier to Oxygen Gas:

As will be appreciated, in the context of packaging materials, the efficacy of the material as a barrier to oxygen gas can be a significant factor in the performance of the packaging material.

Samples of film materials of PLGA:CA blends (as per Table 2, below) were prepared by the method described above, and then coated on substrates at a coating weight of 20 gsm, each substrate including the Applicant's thermoformed pulp fibre sheet. These samples were subjected to oxygen transmission rate (OTR) tests using a MOCON OX-TRAN Oxygen Permeation Analyzer Model 2/22. Additionally, an indexing sample of a film material of pure PLGA was prepared substantially by a method as described above but for the omission of the second polymer (cellulose acetate), and then coated on a substrate also at a coating weight of 20 gsm, the substrate including thermoformed pulp fibre sheet.

For comparative purposes, the test results of Samples 6, 7, and 8 (being film materials of PLGA:CA blends) are indexed to Sample 5. Thus, the indexed oxygen transmission rate (OTR) of Samples 6, 7, and 8 are proportional to the result of the index sample (Sample 5), and hence the Indexed OTR value for Sample 5 is 1.

TABLE 2

| Sample | PLGA | CA | Indexed |
|---|---|---|---|
| No. | % | % | OTR |
| 5 | 100 | 0 | 1.00 |
| (index | | | |
| sample) | | | |
| 6 | 75 | 25 | 0.61 |
| 7 | 50 | 50 | 0.28 |
| 8 | 25 | 75 | 0.22 |

The above results are shown graphically in FIG. 2. These results indicate that the oxygen gas barrier properties of film material that is a PLGA:CA blend increases with increasing proportion of cellulose acetate (CA).

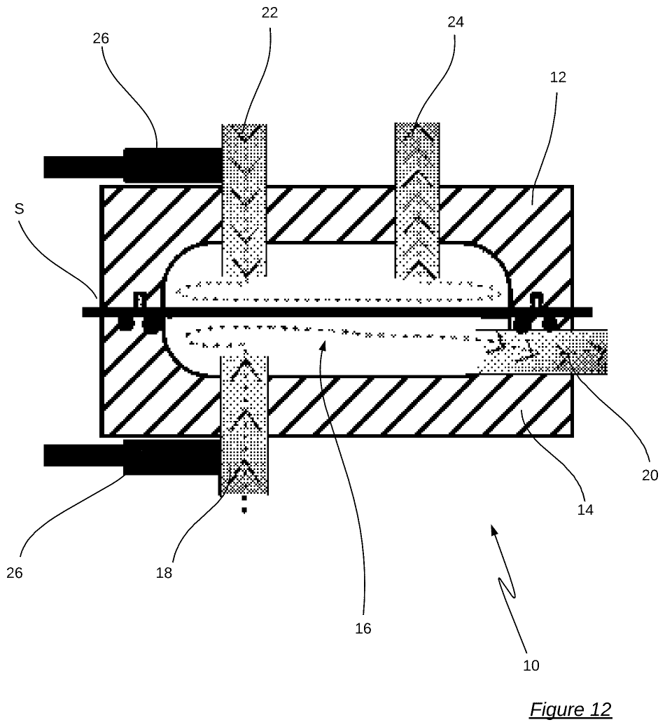

The test cell of the MOCON OX-TRAN Oxygen Permeation Analyzer Model 2/22 is illustrated schematically in FIG. 12, and described below.

### Barrier to Liquid Water:

As will be appreciated, in the context of packaging materials, the efficacy of a barrier to liquid water can be a significant factor in the performance of the packaging material.

A Cobb test is a measure of water absorbency into a surface. Specifically, the test determines the amount of water absorbed into the surface of a material in a set period of time. The Cobb test measures the amount of water absorbed by a material (in g/m², or “gsm”), with a standard area exposed to water for a predetermined time period. Subjecting a sample of a material having a substrate that is coated with a film of PLGA:CA blend as prepared above to a Cobb test provides a measure of the ability of the film to act as a barrier to liquid water.

Samples of films of PLGA:CA blends (as per Table 3, below) formed on thermoformed pulp fibre sheets to nominal coating weights were prepared by the method described above. Additionally, a sample of a film of pure PLGA formed on a thermoformed pulp fibre sheet was also prepared by the method described above.

TABLE 3

| | | | Film | Water |
|---|---|---|---|---|
| Sample | PLGA | CA | weight | absorbency |
| No. | % | % | (gsm) | (gsm) |
| 10 | 100 | 0 | 20 | 5.50 |
| 11 | 75 | 25 | 20 | 0.84 |
| 12 | 50 | 50 | 10 | 2.75 |
| 13 | 50 | 50 | 20 | 0.85 |
| 14 | 50 | 50 | 30 | 0.76 |
| 15 | 25 | 75 | 20 | 3.31 |

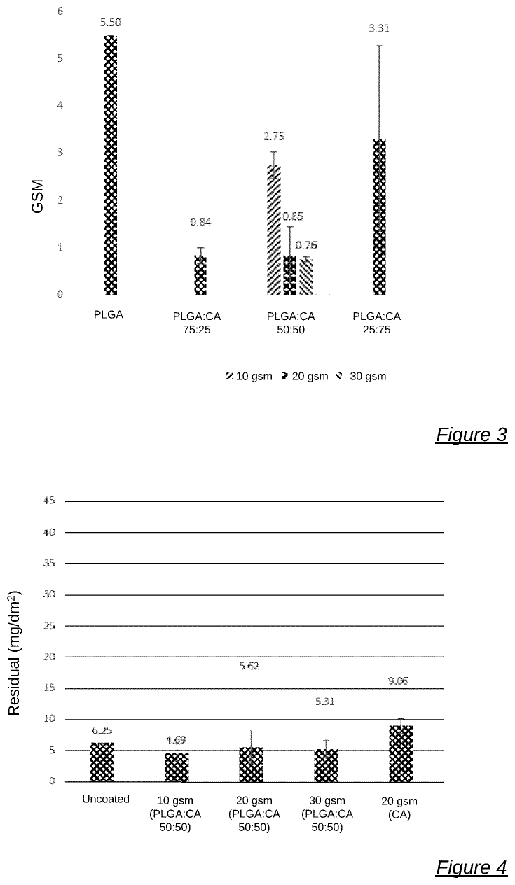

The above results are shown in the column chart of FIG. 3. These results indicate generally that the liquid water barrier properties of film material that is a PLGA:CA blend:
has an optimal value where cellulose acetate is present in the blend, but is less than 75%; and
may increase (possibly exponentially) with increasing coat weight of film material.

The results of the tests described above, in respect of Samples 1 to 15, indicate that the film material that is formed of the PLGA and CA components in the ratio of approximately 50:50 by weight provides beneficial barrier performance in respect of water vapour, oxygen (gas), and liquid water, collectively.

### Migration of PLGA:CA Film to Packaged Goods:

As will be appreciated, in the context of packaging materials that are intended for use in packaging consumable goods, migration of the packaging material into the consumable goods is detrimental to those goods.

A migration test is a measure of the residue of material that has migrated (in other words, leached) from that material into goods stored in contact with that material. Subjecting a sample of a material having a substrate that is coated with a film of PLGA:CA blend to a migration test provides a measure of the capacity of the film material to migrate into consumable goods.

Samples of films of PLGA:CA blends (as per Table 4, below) formed on thermoformed pulp fibre sheets to nominal coating weights were prepared by the method described above. Additionally, a sample of uncoated thermoformed pulp fibre sheet, and a sample of a film of pure CA formed on a thermoformed pulp fibre sheet was also prepared by the method described above.

The migration tests were conducted by the Applicant in accordance with European Standard EN 1186-9 for materials in contact with foodstuffs. The test involves contacting an aqueous food simulant material with the sample material, and subjecting the simulant material and sample to a temperature of 100° C. for 30 minutes. European food contact material regulations require that migration residue values less than <10 mg/dm² are required of packaging materials.

TABLE 4

| | | | Film | Residue |
|---|---|---|---|---|
| Sample | PLGA | CA | weight | amount |
| No. | % | % | (gsm) | (mg/dm²) |
| 16 | — | — | — | 6.25 |
| (uncoated) | | | | |
| 17 | 50 | 50 | 10 | 4.69 |
| 18 | 50 | 50 | 20 | 5.62 |
| 19 | 50 | 50 | 30 | 5.31 |
| 20 | 0 | 100 | 20 | 9.06 |

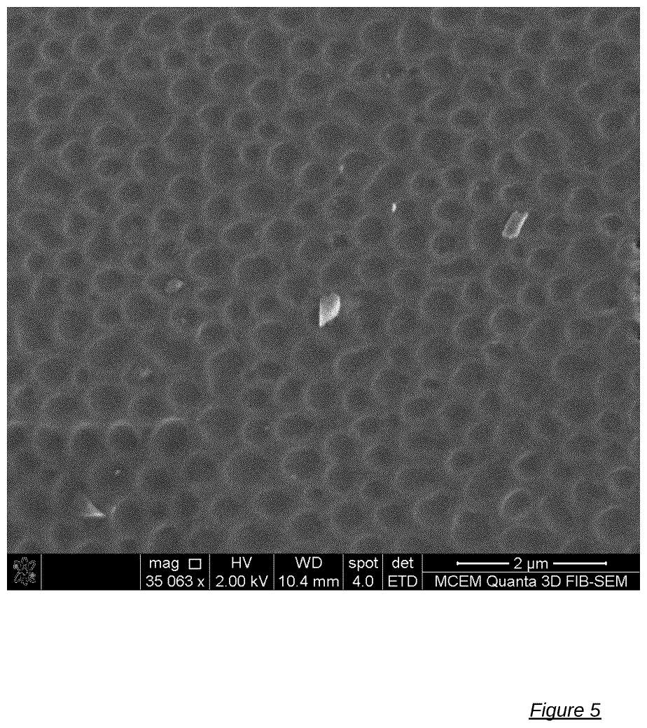

The above results are shown in the column chart of FIG. 4. These results indicate that film materials with PLGA:CA blends of 50:50 have residue amounts that meet European food contact material regulations.

### Example 2: Synthesis of a Low Molecular Weight PLGA from Bio-Based Monomers

### Chemicals:

Lactic acid:
   obtained from Sigma Aldrich (Product No. W261114),
   in liquid form, assay at 85% by vol, remaining 15% containing water, higher oligomers of lactic acid and other FEMA GRAS components,
   used as received;
Glycolic acid:
   obtained from Sigma Aldrich (Product No. 124737),
   in powder form, assay at 99%,
   used as received;
Tin(II) 2-ethylhexanoate:
   obtained from Sigma Aldrich (Product No. S3252),
   in liquid form, assay at 92.5-100%,
   used as received;
Chloroform:
   obtained from Sigma Aldrich (Product No. C2432),
   in liquid form,
   used as received;
Methanol:
   obtained from Sigma Aldrich (Product No. 179957),
   in liquid form,
   used as received.

### Method:

Appropriate quantities of lactic acid and glycolic acid feed were mixed to achieve the desired monomer feed ratio, and then heated to 160° C. under a moderate partial vacuum (100 mBar), and maintained for 2 hours with constant stirring. The polymerization catalyst (tin(II) 2-ethylhexanoate) was then charged into the reaction, and the temperature increased to 180° C. and the partial vacuum increased (to <5 mBar), and maintained for between 4 and 16 hours with constant stirring. The post synthesis reaction mixture was cooled to room temperature, and dissolved in chloroform. Methanol was then added to the solution, and the reaction solution was then stirred and left to separate. The resultant supernate was poured off. Remaining solute was driven off the precipitate by a stream of compressed air. Finally, the precipitate was dried in a vacuum oven at 35° C. for 24 hours, thus leaving the synthesized poly(lactic-co-glycolic acid) (PLGA) in powder form.

PLGA polymer was prepared with a lactic acid to glycolic acid monomer feed mol ratio of 50:50.

### Analysis:

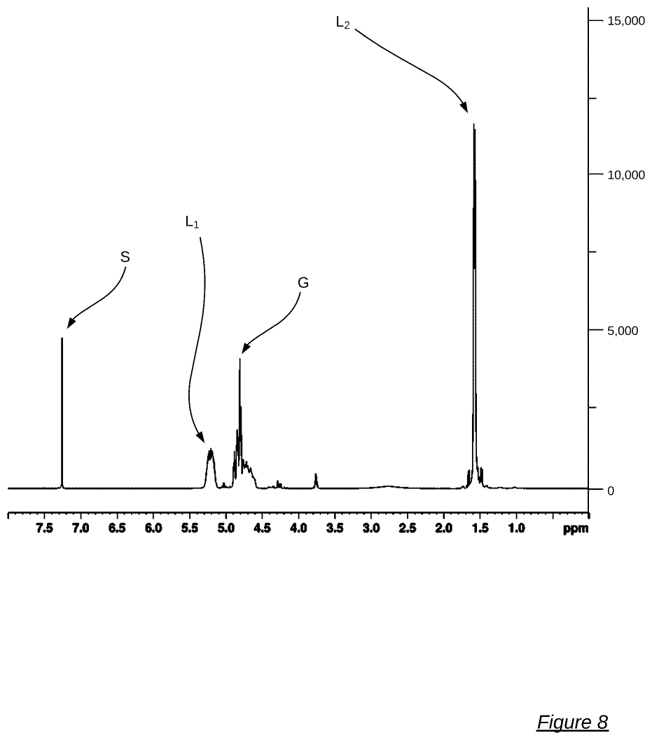

A sample of PLGA synthesized as described above was analysed using a Bruker Nuclear Magnetic Resonance (NMR) spectrometer. FIG. 8 is a graph showing the proton (1H) nuclear magnetic resonance spectrum of the sample. For this analysis, the sample was dissolved in chloroform (CHCl₃).

In FIG. 8, the clusters in the spectrum are as follows:

| Peak | | Material/ |
|---|---|---|
| Centre | | Functional |
| (ppm) | H's | group |
| 7.28 | 1 | Chl |
| 5.21 | 1 | L₁ |
| 4.89 | 2 | G |
| 1.58 | 3 | L₂ |

In which:
Chl: corresponds with the chloroform solvent,
L₁: corresponds with the methine group of the lactate component in the sample,
G: corresponds with the methylene group of the glycolate component in the sample,
L₂: corresponds with the methyl group of the lactate component in the sample, and
“H's”: is the number of hydrogen atoms in the respective functional group.

Using signal strength values of the methine groups of Lactate (L₁), and methylene groups of Glycolate (G) present in the sample, the proportion of glycolic esters present in the sample can be calculated, as follows:
L₁ strength (I_{L})=0.7, and G strength (I_{G}): 0.96

$$\begin{matrix}\% Glycolic acid = ( \frac{{I}_{G}}{2 ( {I}_{L} ) + {I}_{G}} ) \times 100 \\ = ( \frac{0.96}{2 ( 0.7 ) + 0.96} ) \times 100 \\ = 40.67 \%\end{matrix}$$

Thus, the results obtained from the proton NMR spectroscopy (and shown in FIG. 8) are indicative of the sample having a ratio of lactic-to-glycolic units in the polymer of approximately 60:40.

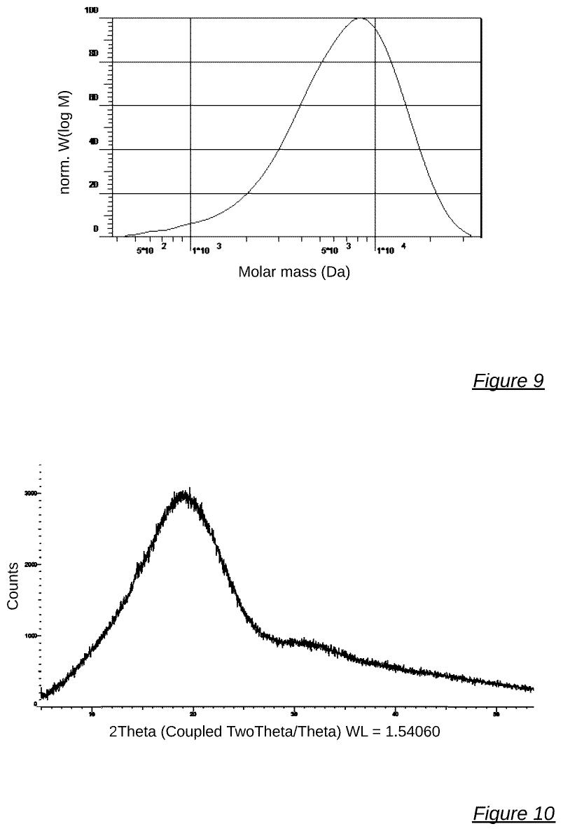

A sample of PLGA synthesized as described above was analysed using a gel permeation chromatograph. FIG. 9 is the graph showing molecular weight distribution of the sample. The results from the gel permeation chromatography analysis reveal that the sample had:
a number average molecular weight (M̅n̅) of: 4.857×10³ g/mol
a weight average molecular weight (M̅w̅) of: 8.116×10³ g/mol
polydispersity index (PDI) of: 1.67

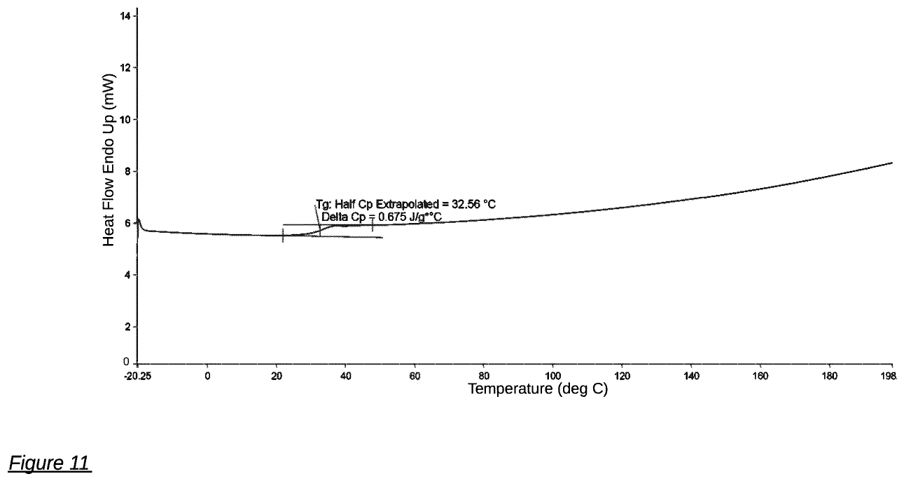

A sample of PLGA synthesized as described above was analysed using an x-ray diffractometer. FIG. 10 is a graph showing intensity (Counts) against phase angle (2θ) from the x-ray diffraction analysis. The results from this analysis are indicative of the sample material having 40% crystallinity, and the remainder (60%) being amorphous.

A sample of PLGA synthesized as described above was analysed using a differential scanning calorimeter. FIG. 11 is a graph showing heat flow (mW) against temperature (° C.) from the differential scanning calorimetry analysis. The results from this analysis are indicative of the sample having a glass transition temperature (Tg) of approximately 32.56° C.

It is to be understood that tin(II) 2-ethylhexanoate is also known to those in the art as “tin octoate”, “tin(II) octoate”, and/or “stannous octoate”, and are polymerization catalysts compounded with tin.

It will be appreciated that the method of Example 2 that is described above involves synthesis of PLGA by polycondensation. Synthesis of PLGA having the same, or substantially similar, characteristics could be achieved by other polymerization techniques. By way of example only, chain-growth polymerization techniques, such as ring-opening, could be employed.

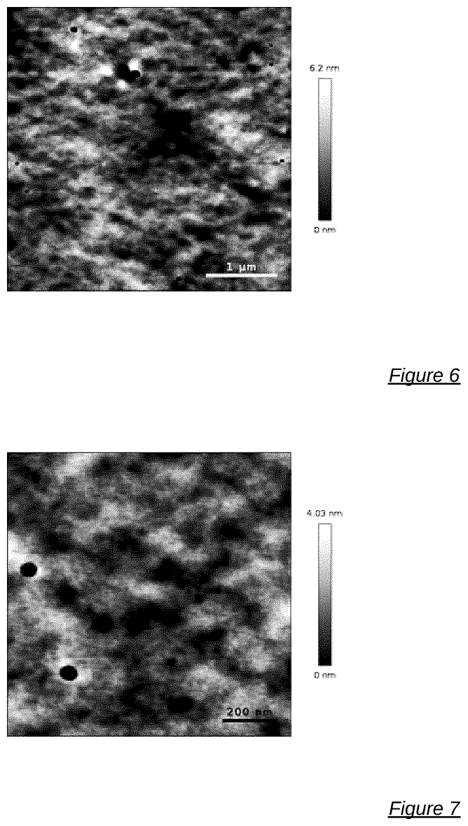

FIG. 5 is a scanning electron microscope (SEM) image of a surface of a film material formed of a PLGA:CA blend that has been prepared according to Example 1, the film material having substantially equal parts the two polymers present in the blend. The image of FIG. 5 is generated to micrometre scale resolution in the image plane, with the scale indicated in the image. In the SEM image, the PLGA component of the blend can be discerned by the dark grey regions of the surface that are encircled by light grey ring-like formations. The CA component of the blend can be discerned by the mid-grey regions. Thus, the SEM image suggests that within the film material, regions of PLGA are dispersed within an interconnecting matrix of cellulose acetate.

FIGS. 6 and 7 are atomic force microscopy (AFM) images of a surface of a film material formed of a PLGA:CA blend that has been prepared according to Example 1, the film material having substantially equal parts the two polymers present in the blend. The image of FIG. 6 is generated to micrometre scale resolution in the image plane, with the scale indicated in the image. The image of FIG. 7 is a portion of the surface of the film material shown in FIG. 6, and is enlarged to nanometre scale resolution in the image plane, with the scale indicated in the image. In each image, the surface height is represented by the image shading, with the range of high to low regions represented correspondingly by light to dark colouring in the image as per the shading bar to the right of the actual image.

The AFM image of FIG. 6 indicates that the surface of the film material has a maximum peak-to-trough surface height difference within the image field of approximately 6.2 nanometres (in other words, 6.2×10⁻⁹ m). The AFM image of FIG. 7 indicates a surface of the film material has a peak-to-trough surface height difference within the image field of approximately 4.03 nanometres (in other words, 4.03×10⁻⁹ m).

Further assessment of the images of FIGS. 6 and 7 suggest that within the PLGA:CA blend, the two polymers remain highly mixed through the solvent drying process.

It is understood by the Applicant that the relatively low molecular weight of the synthesized PLGA maintains the highly mixed structure of the blend. This enables PLGA:CA blends according to embodiments to achieve surprisingly high barrier properties in respect of both water vapour and oxygen within the same material. In addition, these PLGA:CA blends can simultaneously possess the strength and hydrophobicity of cellulose acetate (CA), and the pliability and low oxygen permeation of poly(lactic-co-glycolic acid) (PLGA). The benefits of a strong yet pliable polymeric material, with surprisingly high resistance to both water vapour and oxygen transmission are provided within the same material; a benefit that has not been suggested by known bio-based and biodegradable polymer blends. These high barrier properties are not consistent with conventional understandings of PLGA or CA, not least because the properties of a film material that is formed from either PLGA or CA individually suggest that acceptable or even desirable WVTR and OTR properties should not be simultaneously attainable from a blend of these materials. Similarly, with regard to film materials formed from individual polymers of other bio-based monomers.

In addition, the additional properties of PLGA:CA blends according to embodiments achieve migration performance and barrier to liquid water that are also surprising.

Additional benefits of film materials formed of PLGA:CA blends according to embodiments include: that the materials are bio-sourced, that the film materials are biodegradable and/or are compostable, that the materials have desirable flexibility, brittleness, and clarity properties.

FIG. 12 is a schematic vertical cross section of an oxygen permeation test cell 10. The cell 10 has an upper shell part 12 and a lower shell part 14 that close against one another to define an internal cavity 16. A test sample S can be captured between the upper and lower shell parts 12, 14. Contact faces of each of the upper and lower shell parts 12, 14 are configured to create a seal against the test sample S.

As shown in FIG. 3, with the test sample S captured between the upper and lower shell parts 12, 14, the cavity 16 is divided into an upper cavity region and a lower cavity region.

The lower shell part 14 has an oxygen (O₂) gas inlet 18, through which oxygen gas is fed into the cavity 16. A vent 20 is configured to vent the cavity 16 to a nominal cavity pressure, which is typically atmospheric pressure. In this way, the lower cavity region can be charged with oxygen gas, and maintained at the nominal cavity pressure.

The upper shell part 12 has a carrier gas inlet 22, through which a carrier gas is fed into the cavity 16. The carrier gas is typically nitrogen (N₂), and during a test the nitrogen gas is fed in at a relatively constant flow rate via the gas inlet 22. The upper shell part 12 also has a sample gas outlet 24. During a test, the carrier gas displaces gas from within the upper cavity region, the displaced gas exiting the cavity 16 via the sample gas outlet 24. The quantity of oxygen present in the displaced gas that is exhausted via the sample gas outlet 24 can be analysed to determine the oxygen transmission rate of the test sample S.

Each of the oxygen (O₂) gas inlet 18 and carrier gas inlet 22 include a humidity sensor 26 to facilitate accurate and reliable testing of the sample.

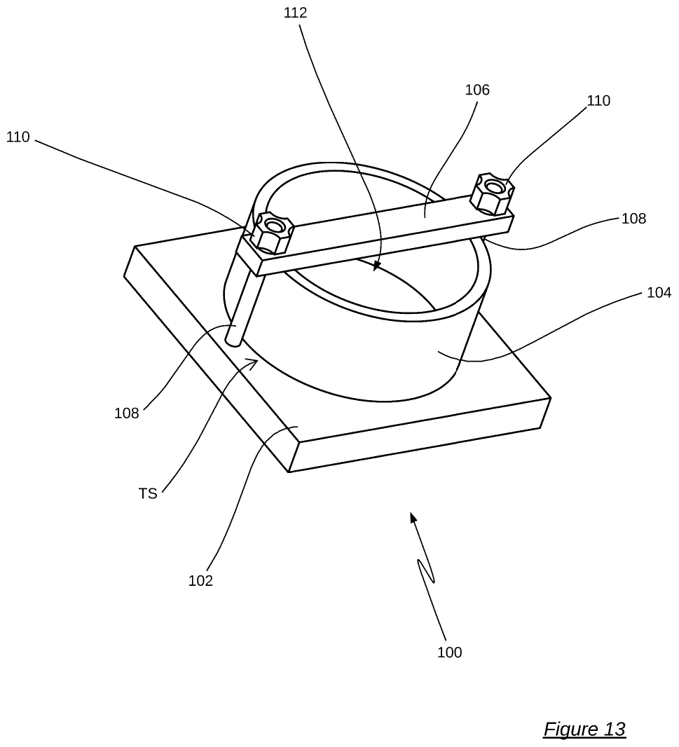

FIG. 13 is a schematic view of a Cobb testing apparatus 100. The apparatus 100 includes a base plate 102, and a cylindrical shell 104. In use of the apparatus 100, a test sample is inserted between the base plate 102 and the base of the cylindrical shell 104. In FIG. 13, the test sample position is indicated by arrow TS.

A pair of posts 108 are fixed to the base plate 102. A clamping bar 106 is installed across the top of the cylindrical shell 104, with posts 108 passing through holes in the clamping 106. Threaded fasteners 110 are then tightened to compress the test sample between the base plate 102 and the cylindrical shell 104.

The cylindrical shell 104 has a determined internal diameter, which enables the internal cavity 112 to be filled to a predetermined volume, for example by filling the inside of the shell 104 to a predetermined depth. In an actual test, the test sample is exposed to water for a predetermined period of time, usually 60 or 180 seconds (known respectively as the Cobb60 or Cobb180 test).

### Example 3: Synthesis of Film Materials

### Chemicals:

Poly(lactic-co-glycolic acid) (PLGA):
   obtained from Advanced Molecular Technologies Pty Ltd, synthesized on commission and to the Applicant's specification,
   in powder form,
   used as received;
Cellulose Acetate Butyrate (CAB):
   obtained from Eastman (Product No. CAB-381-0.5),
   in powder form,
   used as received (referred to herein as “CAB 381-0.5 (Eastman)”);
Cellulose Acetate Propionate (CAP):
   obtained from Sigma Aldrich (Product No. 340642),
   in powder form,
   used as received (referred to herein as “CAP (Sigma)”);
Cellulose Acetate Propionate (CAP):
   obtained from Eastman (Product No. CAP-482-0.5, Food Contact),
   in powder form,
   used as received (referred to herein as “CAP 482-0.5 (Eastman)”);
Acetone:
   obtained from Merck (Product No. 100014),
   reagent grade,
   used as received.

Analysis of results obtained from proton NMR spectroscopy of the PLGA indicated a ratio of lactic-to-glycolic units in the polymer of approximately 60:40.

### Substrate Materials:

Derwent tracing paper:
   92 gsm,
   retail grade,
   used as received.

### Method:

As per Example 1. All coating materials were prepared with a PLGA molar fraction of 50% by weight, with the balance being the acetylated cellulose derivative component, in solution with acetone.

The polymer blends in solution were delivered to the substrate material to achieve coat weight of 30 gsm.

### Analysis:

Samples of films of the coating material blends formed on the substrate material. Each sample was subjected to OTR and WVTR tests, as detailed in the Analysis of Example 1. The results are set out in Table 5 below.

TABLE 5

| Sample | Second | OTR (cc/ | WVTR (g/ |
|---|---|---|---|
| No. | polymer | (m² × day)) | (m² × day)) |
| 21 | CAB 381-0.5 | 1.18 | 54.10 ± 3.45 |
| | (Eastman) | | |
| 22 | CAP (Sigma) | 0.9 | 62.50 ± 1.65 |
| 23 | CAP 482-0.5 | 1.00 | 53.57 ± 1.64 |
| | (Eastman) | | |

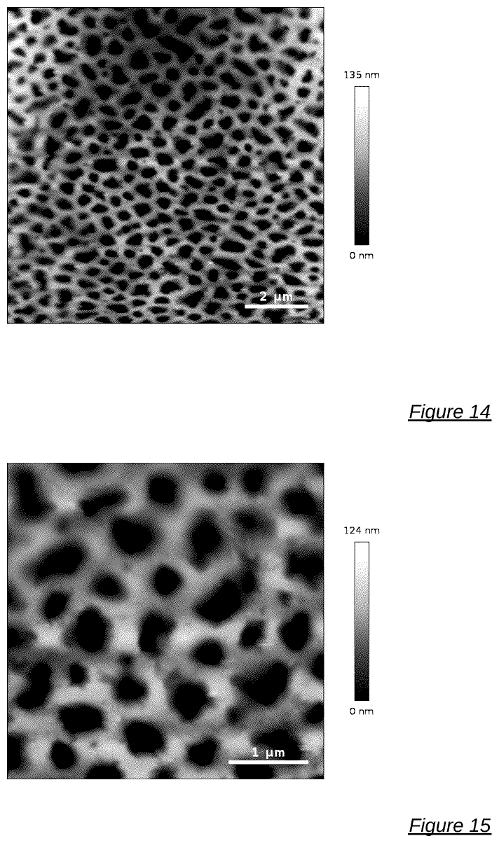

FIGS. 14 to 17 are atomic force microscopy (AFM) images of surfaces of film materials formed of blends of the PLGA of Example 3, with a second polymer (cellulose acetate, or an acetylated cellulose derivative), as detailed in Table 6 below. All samples were prepared with a PLGA molar fraction of 50% by weight, with the balance being the second polymer, and delivered to a substrate material.

The images are generated to micrometre scale resolution in the image plane, with the scale indicated in the respective image. Maximum peak-to-trough surface height difference for each sample, within the image field, are set out in Table 6.

Sample 24 was prepared in accordance with Example 1, but with the PLGA component of Example 3.

TABLE 6

| | | Surface | |
|---|---|---|---|
| Sample | Second | Height | Figure |
| No. | polymer | (×10⁻⁹ m) | No(s). |
| 24 | CA | 135 | 14, 15 |
| 25 | CAP (Sigma) | 391 | 16 |
| 26 | CAB 381-0.5 | 513 | 17 |
| | (Eastman) | | |

The image of FIG. 15 is an enlarged portion of the surface of the film material shown in FIG. 14.

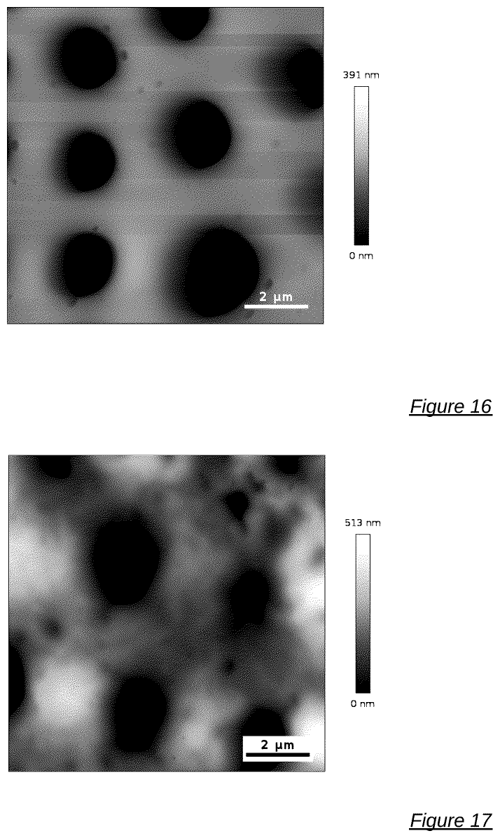

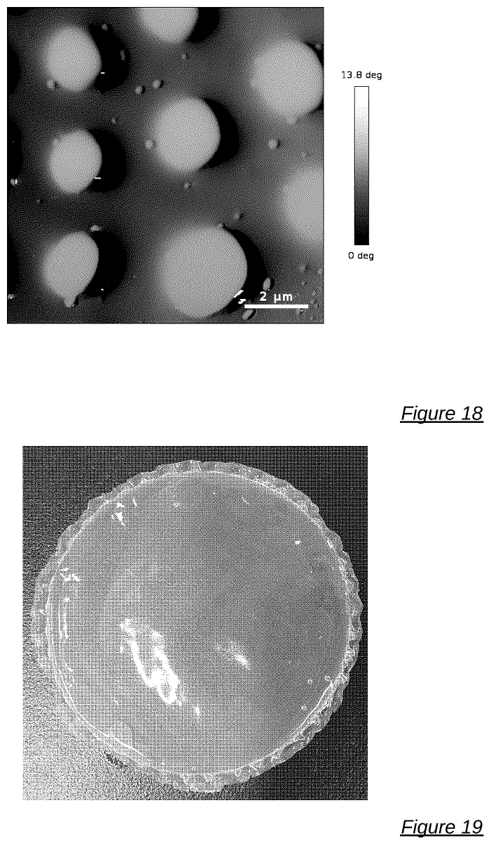

FIG. 18 is an AFM phase image of Sample 25, thus corresponding with the surface image of FIG. 16. In this image, the phase shift is represented by the image shading, with the range of phase shift from 0° to 13.8° (maximum) represented correspondingly by dark to light colouring in the image as per the shading bar to the right of the actual image. With respect to Sample 25, it is understood that the PLGA component is softer, and/or has greater adhesive properties to the AFM probe tip compared with the CAP (Sigma) component in the film material.

In the surface images of FIGS. 14 to 17, the PLGA is discernible by the dark regions that are recessed below, and surrounded by, the interconnecting matrix of the second polymer.

Analysis of FIGS. 5 to 7, and 14 to 18 indicates that the polymer blends of each film material form a continuous film. Within the surface layer of each film material, the respective second polymer (CA, CAP, CAB) is arranged as a substantially continuous matrix surrounding regions of the PLGA. Further, within the surface layer of each film material, the regions of PLGA of varied size and/or separation.

### Example 4: Synthesis of Film Material

### Chemicals:

Poly(lactic-co-glycolic acid) (PLGA):
   obtained from Advanced Molecular Technologies Pty Ltd, synthesized on commission and to the Applicant's specification,
   in powder form,
   used as received;
Cellulose acetate (CA):
   obtained from Eastman (Product No. CA-398-3, Food Contact),
   in powder form,
   acetylation: 39.8% (by weight),
   used as received;
Acetone:
   obtained from Merck (Product No. 100014),
   reagent grade,
   used as received.

### Method:

PLGA and CA at a molar ratio of 50:50 by weight were dissolved in acetone and then heated to 20° C. to 30° C., and ideally 25° C., and maintained for up to 2 hours with constant stirring until dissolved, to form a PLGA:CA blend in solution.

The PLGA:CA blend in solution was delivered to a silicone curing vessel, at a mass to achieve a desired film thickness. The acetone solvent was allowed to evaporate at standard laboratory temperature:
on a laboratory bench for a period in the range of 20 minutes to 60 minutes, and ideally 30 minutes, and
then in an environment with an increased cross flow air stream for a second period in the range of 20 minutes to 60 minutes, and ideally 30 minutes.

Once the acetone solvent had evaporated, the film material was peeled from the curing vessel.

FIG. 19 is a photograph of a film material that was prepared in accordance with the method described above.

### Analysis:

### Barrier to Water Vapour:

Samples of films of PLGA:CA blends (as per Table 7, below) formed to varying thicknesses were prepared by the method described above. These samples were subjected to water vapour transmission rate (WVTR) tests, with air at 23° C. and 50% relative humidity (RH) as the migration test agent.

TABLE 7

| Sample | Thickness | WVTR (g/ |
|---|---|---|
| No. | (μm) | (m² × day)) |
| 27 | 60 | 109.61 ± 18.80 |
| 28 | 100 | 77.39 ± 16.04 |
| 29 | 200 | 70.19 ± 11.25 |

The above results indicate that the water vapour barrier properties of the film materials in accordance with Example 4 increase with film thickness.

The term “bio-based monomer” refers to monomers that originate from renewable resources/renewable feedstock. These include monomers that are obtained from living organisms, are naturally produced, and/or are derived from living organisms. Similarly, the term “bio-sourced” refers to materials that originate from renewable resources/renewable feedstock. These include materials that are obtained from living organisms, are naturally produced, and/or are derived from living organisms.

The term “biodegradable” is recognized in this art, and includes polymers, compositions and formulations, such as those described herein, that are intended to degrade during use by biological means, such as bacteria and fungi in addition to degradation, by other chemical processes such as hydrolytic, oxidative and enzymatic processes, and/or by anaerobic means. Such use involves degradation to produce release of the active and regulate release of the active. In general, degradation attributable to biodegradability involves the degradation of a biodegradable polymer into its component sub units, monomers, and oligomers, and eventually into nontoxic byproducts.

In this specification and the claims that follow, the expression “degree of acetylation” is to be understood to mean the average number of acetyl groups per carbohydrate unit within the material. The degree of acetylation may also be expressed as the “degree of substitution”, to indicate the average number of hydroxyl groups that are substituted with acetyl groups per carbohydrate unit within the material. To this end, it will be understood that for cellulose acetate, each carbohydrate unit can have 1, 2 or 3 acetyl groups after acetylation, and the degree of acetylation is a value representative of the extent of substitution (of acetyl groups for hydroxyl groups).

In this specification and the claims that follow, any reference to a monomer, polymer, or copolymer is to be understood to include all stereoisomeric forms (in other words, chiralities) that may exist for that respective monomer, polymer or copolymer, except where the context explicitly states or indicates otherwise. By way of non-limiting example, a reference to monomer that has stereoisoforms is to be understood to include the compound in any of: substantially exclusively its L-isoform, substantially exclusively its D-isoform, and combinations of both L- and D-isoforms (unless explicitly stated/indicated otherwise). Similarly, a polymer that is formed of one or more monomers that have stereoisoforms is to be understood to include the polymer having, for each monomer, any of: substantially exclusively its L-isoform, substantially exclusively its D-isoform, and combinations of both L- and D-isoforms (unless explicitly stated/indicated otherwise).

In this specification, the terms “consumable goods” and “goods” as used herein refer to those products that deteriorate (in other words, degrade, decay, perish and/or decompose) over time, and which are most desirable for their intended use with the least deterioration. Thus, “consumable goods” and “goods” includes food and beverage products for human or animal consumption; pharmaceuticals, nutraceuticals, and dietary supplements for human or animal use; and cosmetics. For avoidance of doubt, “consumable goods” and “goods” is also to include various garden and household products that are intended for use by humans/animals, but not for ingestion. It is to be understood that this is not an exhaustive list of products that are “consumable goods” and/or “goods”.

Throughout this specification and the claims which follow, unless explicitly stated otherwise, references to “molecular weight” are to be understood to refer to “weight average molecular weight”.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1-46. (canceled)

47. A packaging material comprising:
a substrate; and
at least one layer that is formed of a film material that includes a blend of:
a first polymer that is synthesized from one or more bio-based monomers, the first polymer being an aliphatic polyester selected from the group consisting of: poly(lactic acid), poly(glycolic acid), copolymers of lactic and glycolic acid, copolymers of lactic and glycolic acid with poly(ethylene glycol), poly(e-caprolactone), and poly(3-hydroxybutyrate), the first polymer having a molecular weight that is less than or equal to 60 kilodaltons; and
a second polymer that is one of: a carbohydrate, and a functionalized carbohydrate derived from one or more bio-based materials, the ratio of first polymer to second polymer within the film material being at least 25:75 by weight,
the at least one layer being assembled into a substantially continuous film on a carrying surface of the substrate,
wherein the at least one layer is formed to a thickness that is efficacious in providing a barrier to transmission of oxygen and/or water vapor to the carrying surface of the substrate.

48. The packaging material of claim 47, wherein the first polymer has a molecular weight that is less than or equal to 30 kilodaltons.

49. The packaging material of claim 47, wherein the first polymer has a molecular weight that is less than or equal to 15 kilodaltons.

50. The packaging material of claim 47, wherein the first polymer has a molecular weight that is in the range of 4.5 kilodaltons to 7.5 kilodaltons.

51. The packaging material of claim 47, wherein the first polymer has a polydispersity index that is less than or equal to 3.

52. The packaging material of claim 47, wherein the ratio of first polymer to second polymer within the film material is approximately 50:50 by weight.

53. The packaging material of claim 47, wherein the first polymer is synthesized from monomers of lactic acid and glycolic acid.

54. The packaging material of claim 47, wherein the first polymer is poly(lactic co glycolic acid) (PLGA).

55. The packaging material of claim 54, wherein the poly(lactic-co-glycolic acid) is formed so as to have lactic and glycolic units at a ratio of approximately 60:40.

56. The packaging material of claim 47, wherein the second polymer is an acetylated cellulose derivative.

57. The packaging material of claim 56, wherein the acetylated cellulose derivative is one or more of: cellulose acetate, cellulose acetate butyrate, and cellulose acetate propionate.

58. The packaging material of claim 57, wherein the acetylated cellulose derivative is cellulose acetate.

59. The packaging material of claim 58, wherein the cellulose acetate has a degree of acetylation that is in the range of 1 to 3.

60. The packaging material of claim 47, wherein the, or each layer of film material is formed to a thickness of at least 5 grams/metre2 (gsm).

61. The packaging material of claim 47, wherein the, or each layer of film material is formed to an average thickness that is at least 2.5 μm.

62. The packaging material of claim 47, wherein the layer of the film material that defines an external surface of the packaging material.

63. The packaging material of claim 47, wherein the layer of the film material that defines an internal surface of the packaging material.

64. The packaging material of claim 47, wherein the substrate is formed of pulp fibers that have been processed so as to be assembled into a predetermined shape and treated to form bonds between the pulp fibers within the substrate, whereby the substrate is able to at least partly retain its shape in an unsupported condition.

65. The packaging material of claim 47, wherein the packaging material is shaped to define a concave portion within which a consumable good is to be packaged, and
wherein the packaging material is arranged with the layer of film material being between the substrate and the concave portion.

66. The packaging material of claim 47, wherein the layer of film material is formed on the substrate at a thickness such that the oxygen transmission rate of the packaging material is less than or equal to 30 cubic centimeters per meter squared per day (cm³/(m2×day)), at 23° C., 50% relative humidity.
